(19) United States
(12) Patent Application Publication
(10) Pub. No.: US 2005/0023096 A1
(43) Pub. Date: Feb. 3, 2005

(54) Bag and method of moving

(75) Inventor: Paolo M.B. Tiramani, Greenwich, CT (US)

Correspondence Address: Ansel M. Schwartz;Attorney at Law, Suite 304, 201 N. Craig Street, Pittsburgh, PA, 15213, US

(73) Assignee: 500 Group, Inc.

(21) Appl. No.: 10/633,118

(22) Filed: Aug. 1, 2003

(51) Int. Cl. B62B 9/00; B62B 7/00

(52) U.S. Cl. 190/18 A; 280/655; 280/37; 280/47.17

(57) ABSTRACT

A bag including a housing having a storage area and a surface. The bag includes an extendable handle connected to the housing. The bag includes an auxiliary wheel unit having at least one castor connected to the surface which in an extended position extends from the surface at an angle of at least 15 degrees to form an extended support base for the housing, and in a retracted state folds against and is essentially in parallel with the surface. The bag includes a release mechanism having a cable which extends from the wheel unit for releasing the wheel unit from the surface to extend into the extended position. Methods for moving a bag. An alternative embodiment of a bag.

### FIELD OF THE INVENTION

The present invention is related to bags, such as luggage and suitcases. More specifically, the present invention is related to bags, such as luggage and suitcases, which have a button assembly connected by a cable to open an auxiliary wheel unit, and a bar which can be depressed to allow the wheel unit to close.

### BACKGROUND OF THE INVENTION

It is the nature of bags, such as luggage or suitcases, that they need to be carried or moved by the user. Many techniques have arisen to facilitate the movement of such bags in a way that makes it as comfortable as possible for the user. One feature that is used with luggage is an auxiliary wheel unit that extends from the luggage and provides a more stable support for the user as the user pulls the luggage along the ground by a handle. The auxiliary wheel unit generally retracts when the user no longer desires to pull the luggage, and needs to be extended when the user does wish to pull the luggage utilizing the auxiliary wheel unit.

A common feature that has been used heretofore in such bags is to somehow link the extension action of the handle that is gripped by the user when the bag is pulled with the extension of the auxiliary wheel unit into its operative position. Similarly, when the handle, that is extended when the bag is pulled by the user, is retracted into the bag for storage, it causes the auxiliary wheel unit to also retract into the bag. Unfortunately, it has been found for a multitude of users that the expansion or retraction of the auxiliary will unit through the extension or retraction of the handle is somewhat difficult, and at times confusing.

The present invention utilizes a remote button in a preferred embodiment, which, when pressed, causes the auxiliary wheel unit to extend for use; and utilizes a bar, which, when pressed when the auxiliary wheel unit is in its extended state, allows the auxiliary will unit to be easily retracted, for instance, essentially in the same motion of the user depressing the bar with his or her foot, and then continuing to push the auxiliary wheel unit until it is retracted.

### SUMMARY OF THE INVENTION

The present invention pertains to a bag. The bag comprises a housing having a storage area and a surface. The bag comprises an extendable handle connected to the housing. The bag comprises an auxiliary wheel unit having at least one castor connected to the surface which in an extended position extends from the surface at an angle of at least 15 degrees to form an extended support base for the housing, and in a retracted state folds against and is essentially in parallel with the surface. The bag comprises a release mechanism having a cable which extends from the wheel unit for releasing the wheel unit from the surface to extend into the extended position.

The present invention pertains to a method for moving a bag. The method comprises the steps of activating a release mechanism having a cable which extends from an auxiliary wheel unit having at least one castor connected to a surface of a housing having a storage area which in an extended position extends from the surface at an angle of at least 15 degrees to form an extended support base for the housing, and in a retracted state folds against and is essentially in parallel with the surface. There is the step of releasing the wheel unit from the surface to extend into the extended position.

The present invention pertains to a bag. The bag comprises a housing having a storage area and a surface. The bag comprises an extendable handle connected to the housing. The bag comprises an auxiliary wheel unit having a back connected to the surface, a front and at least one castor which in an extended state extends from the surface at an angle of at least 15 degrees to form an extended support base for the housing, and in a retracted state folds against and is essentially in parallel with the surface. The wheel unit having a pressure mechanism extending from the front which, when depressed allows the wheel unit to move from the extended state to the retracted state.

The present invention pertains to a method for moving a bag. The method comprises the steps of placing an auxiliary wheel unit having a back connected to a surface of a housing having a storage area, a front and at least one castor into an extended state where the wheel unit extends from the surface at an angle of at least 15 degrees to form an extended support base for the housing. There is the step of pulling the housing by an extendable handle connected to the housing. There is the step of depressing a pressure mechanism of the wheel unit extending from the front which allows the wheel unit to move from the extended state to a retracted state where the wheel unit folds against and is essentially in parallel with the surface. There is the step of moving the wheel unit into the retracted state.

### BRIEF DESCRIPTION OF THE DRAWINGS

In the accompanying drawings, the preferred embodiment of the invention and preferred methods of practicing the invention are illustrated in which:

FIG. 1 is a schematic representation of a bag of the present invention.

FIG. 2a is an exploded view of the button assembly.

FIG. 2b shows the release mechanism.

FIG. 3 is a cross sectional view of the release mechanism in an undepressed date.

FIG. 4 is a cross sectional perspective view of the release mechanism in the undepressed state.

FIG. 5 is a cross sectional view of the release mechanism in a depressed state.

FIG. 6 is a cross sectional perspective view of the wheel unit.

FIG. 7 is a cross sectional view of the wheel unit.

FIG. 9 is a side view of the wheel unit in a partially extended state.

FIG. 8 is a prospective view of the coil spring with the front panel and the back panel.

FIG. 10 is a perspective view of the wheel unit in an extended state.

FIG. 11 is a perspective view of the wheel unit in a partially extended state.

FIG. 12 is a cross sectional view of the castor in a retracted state.

FIG. 13 is a cross sectional view of the castor in an extended state which is weight bearing.

FIG. 14 is an exploded view of the castor.

FIG. 15 is a perspective view of the castor.

FIG. 16 is an exploded view of the bag of the present invention.

FIG. 17 is a perspective view of the wheel unit in a retracted state.

FIG. 18 is a perspective view of the back panel.

FIGS. 19 and 20 are schematic representations of alternative embodiments for placing the wheel unit in a retracted state.

FIGS. 21 and 22 are schematic representations of alternative embodiments for placing the wheel unit in the retracted state.

FIG. 23 is a schematic representation of an alternative embodiment for placing the wheel unit in the retracted state that includes a handle.

FIGS. 24, 25 and 26 are schematic representations of alternative embodiments for placing the wheel unit in a retracted state using a starter reel.

FIGS. 27, 28 and 29 are schematic representations of the handle for placing the wheel unit in the retracted state integrated with a button in a button assembly for allowing the will unit to extend into an extended state.

FIGS. 30-34 are schematic representations of the castor in an embodiment where magnets are used to self-align the castor to be properly positioned for the retracted state.

FIGS. 35-37 are schematic representations of an embodiment where a plunger is used to close the wheel unit.

### DETAILED DESCRIPTION

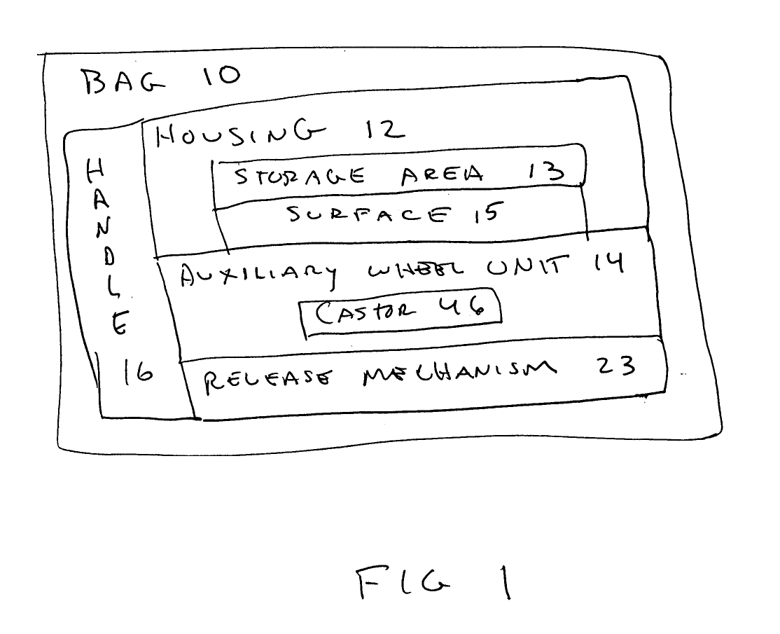

Referring now to the drawings wherein like reference numerals refer to similar or identical parts throughout the several views, and more specifically to FIGS. 1-12 thereof, there is shown a bag 10. The bag 10 comprises a housing 12 having a storage area 13 and a surface 15. The bag 10 comprises an extendable handle 16 connected to the housing 12. The bag 10 comprises an auxiliary wheel unit 14 having at least one castor 46 connected to the surface 15 which in an extended position extends from the surface 15 at an angle of at least 15 degrees to form an extended support base for the housing 12, and in a retracted state folds against and is essentially in parallel with the surface 12. The bag 10 comprises a release mechanism 23 having a cable 31 which extends from the wheel unit 14 for releasing the wheel unit 14 from the surface 15 to extend into the extended position.

Preferably, the release mechanism 23 includes an actuator 24 connected with the cable 31 and remote from the wheel unit 14. The actuator 24 preferably includes a button assembly 67. Preferably, the button assembly includes a button 25 which, when depressed into a depressed state, moves the cable 31 which allows the wheel unit 14 to move to the extendable position. The wheel unit 14 preferably includes a front panel 34, a back panel 35 connected to the surface 15, and a linkage 66 that connects the front panel 34 with the back panel 35.

Preferably, the button assembly 67 includes a lever 27 that engages with the cable 31, and is positioned such that when the button 25 is depressed, the lever 27 is moved by the button 25 and moves the cable 31. The button assembly 67 preferably includes a button spring 26 in operative relationship with the button 25 such that when the button 25 is depressed, the button spring 26 is compressed, and when the button 25 is released, the button spring 26 moves the button 25 from the depressed state back to an undepressed state. Preferably, the release mechanism 23 includes a slider 41 in contact with the wheel unit 14 and the cable 31 so when the button 25 is depressed into the depressed state and the cable 31 is moved, the cable 31 moves the slider 41 and releases the front panel 34 from the back panel 35.

The slider 41 preferably has a latch 43, and the linkage 66 has a front link 36 and a back link 37, and a linkage hinge 48 connected to the front link 36 and the back link 37, the front link 36 having a groove 44 which engages with the latch 43 to hold the front panel 34 with the back panel 35 in the retracted state. Preferably, the wheel unit 14 includes a coil spring 45 which, when the slider 41 is lifted and the latch 43 moves apart from the groove 44, automatically moves the wheel unit 14 into the extended state, where the front link 36 and back link 37 are in linear alignment.

The present invention pertains to a method for moving a bag 10. The method comprises the steps of activating a release mechanism 23 having a cable 31 which extends from an auxiliary wheel unit 14 having at least one castor 46 connected to a surface 15 of a housing 12 having a storage area 13 which in an extended position extends from the surface 15 at an angle of at least 15 degrees to form an extended support base for the housing 12, and in a retracted state folds against and is essentially in parallel with the surface 15. There is the step of releasing the wheel unit 14 from the surface 15 to extend into the extended position.

Preferably, the activating step includes the step of activating an actuator 24 of the release mechanism 23 connected with the cable 31 and remote from the wheel unit 14. The activating step preferably includes the step of depressing a button 25 of a button assembly 67 of the actuator 24 to place the button 25 into a depressed state which moves the cable 31 which allows the wheel unit 14 to move to the extendable position. Preferably, the depressing step includes the step of depressing the button 25 to move a lever 27 which moves the cable 31.

The depressing step preferably includes the step of depressing the button 25 which compresses a button spring 26 in operative relationship with the button 25, and releasing the button 25 so the button spring 26 moves the button 25 from the depressed state back to an undepressed state. Preferably, the depressing step includes the step of moving a slider 41 of the release mechanism 23 in contact with the wheel unit 14 and the cable 31 when the button 25 is depressed into the depressed state and the cable 31 is moved to release the front panel 34 from the back panel 35. The moving step preferably includes the step of lifting a latch 43 of the slider 41 apart from a groove 44 of a front link 36 of a linkage 66 of the wheel unit 14, causing a coil spring 45 attached to the back panel 35 to automatically move the wheel unit 14 into the extended state, where the front link 36 and a back link 37 of the wheel unit 14 are in linear alignment.

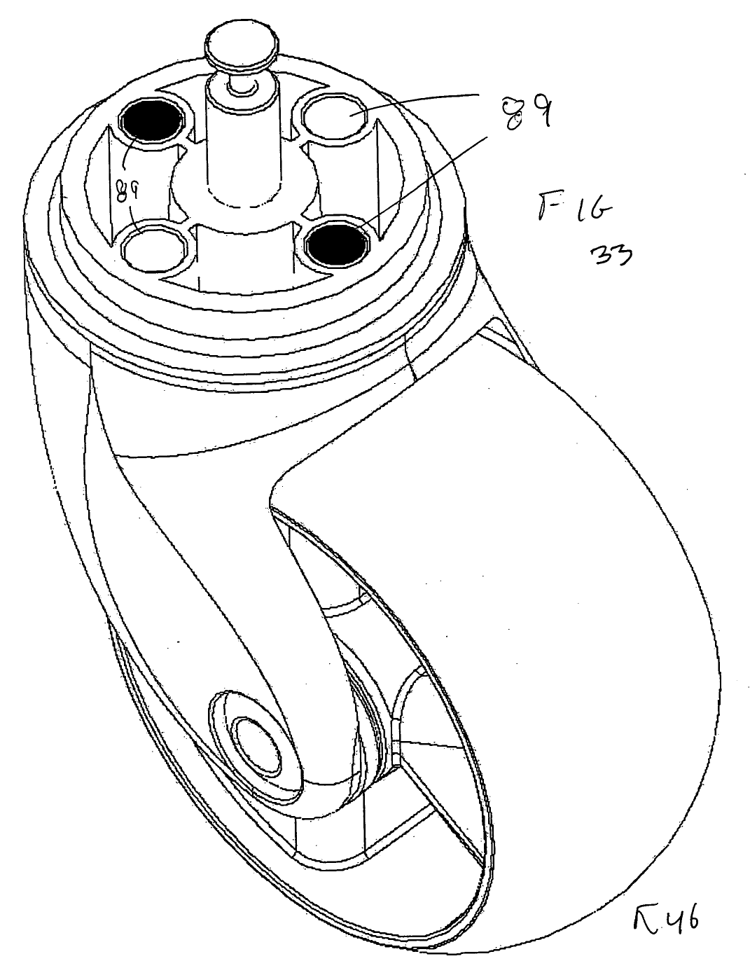

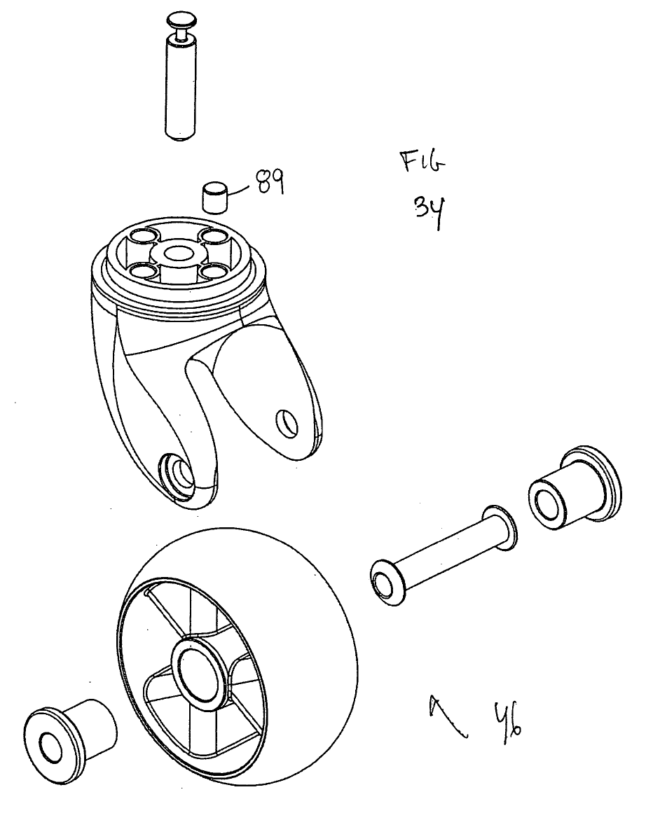

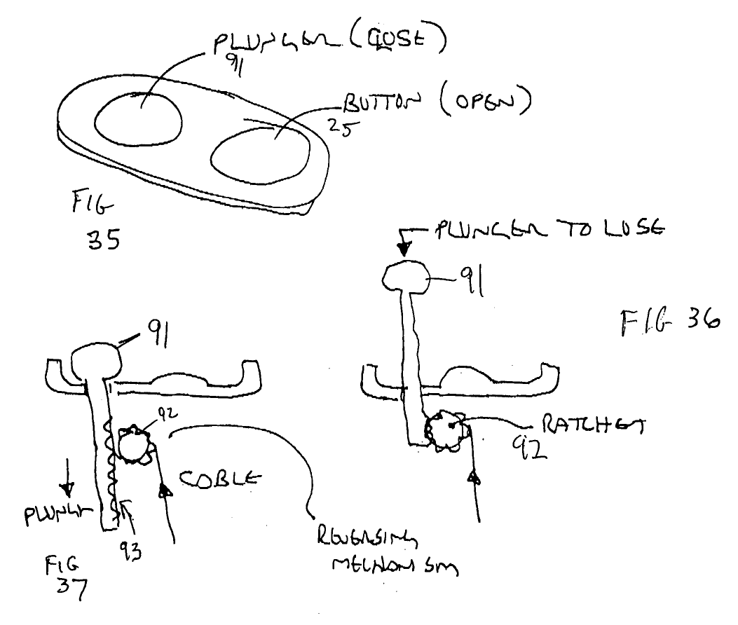

The present invention pertains to a bag 10, as shown in FIGS. 9, 10 and 11. The bag 10 comprises a housing 12 having a storage area 13 and a surface 15. The bag 10 comprises an extendable handle 16 connected to the housing 12. The bag 19 comprises an auxiliary wheel unit 14 having a back 70 connected to the surface 15, a front 71 and at least one castor 46 which in an extended state extends from the surface 15 at an angle of at least 15 degrees to form an extended support base for the housing 12, and in a retracted state folds against and is essentially in parallel with the surface 12. The wheel unit 14 having a pressure mechanism 72 extending from the front 71 which, when depressed allows the wheel unit 14 to move from the extended state to the retracted state.

Preferably, the wheel unit 14 includes a front panel 34 having the front 71, a back panel 35 having the back 70, and a linkage 66 connected to the front panel 34 and the back panel 35. The linkage 66 preferably includes a front link 36 connected to the front panel 34, a back link 37 connected to the back panel 35 and a linkage hinge 48 connected to the front link 36 and the back link 37 about which the front link 36 and the back link 37 rotate as they move between the extended state, where the front link 36 and the back link 37 are in linear alignment, and the retracted state, where the front link 36 and the back link 37 are essentially folded together. Preferably, the pressure mechanism 72 includes a bar 47 disposed along the front 71 of the front panel 34 and connects with the front link 36 so when the wheel unit 14 is in the extended state and the bar 47 is depressed, the front link 36 is caused to be moved relative to the linkage hinge 48, breaking the linear alignment with the back link 37 and allowing the front panel 34 and the front link 36 to be folded together with the back link 37 and the back panel 35.

The present invention pertains to a method for moving a bag 10. The method comprises the steps of placing an auxiliary wheel unit 14 having a back 70 connected to a surface 15 of a housing 12 having a storage area 13, a front 71 and at least one castor 46 into an extended state where the wheel unit 14 extends from the surface 15 at an angle of at least 15 degrees to form an extended support base for the housing 12. There is the step of pulling the housing 12 by an extendable handle 16 connected to the housing 12. There is the step of depressing a pressure mechanism 72 of the wheel unit 14 extending from the front 71 which allows the wheel unit 14 to move from the extended state to a retracted state where the wheel unit 14 folds against and is essentially in parallel with the surface 15. There is the step of moving the wheel unit 14 into the retracted state.

Preferably, the moving step includes the step of rotating a front link 36 connected to a front panel 34 having the front 71 of the wheel unit 14 relative to a back link 37 connected to a back panel 35 having the back 70 of the wheel unit 14 about a linkage hinge 48 connected to the front link 36 and the back link 37 as they move between the extended state, where the front link 36 and the back link 37 are in linear alignment, and the retracted state, where the front link 36 and the back link 37 are essentially folded together. The depressing step preferably includes the step of depressing a bar 47 of the pressure mechanism 72 disposed along the front 71 of the front panel 34 and connected with the front link 36 causing the front link 36 to be moved relative to the linkage hinge 48, breaking the linear alignment with the back link 37 and allowing the front panel 34 and the front link 36 to be folded together with the back link 37 and the back panel 35.

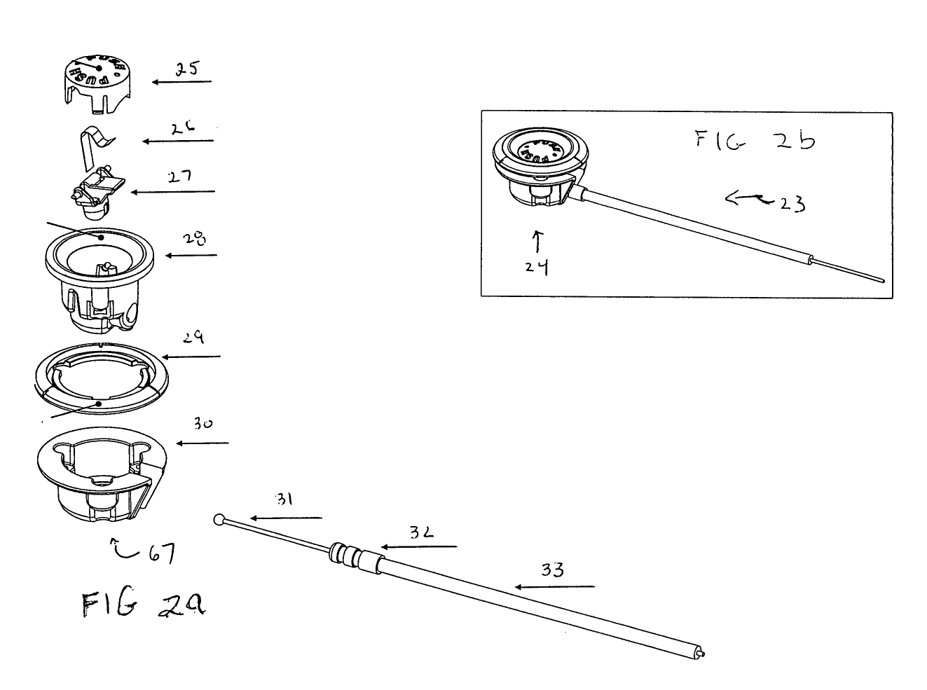

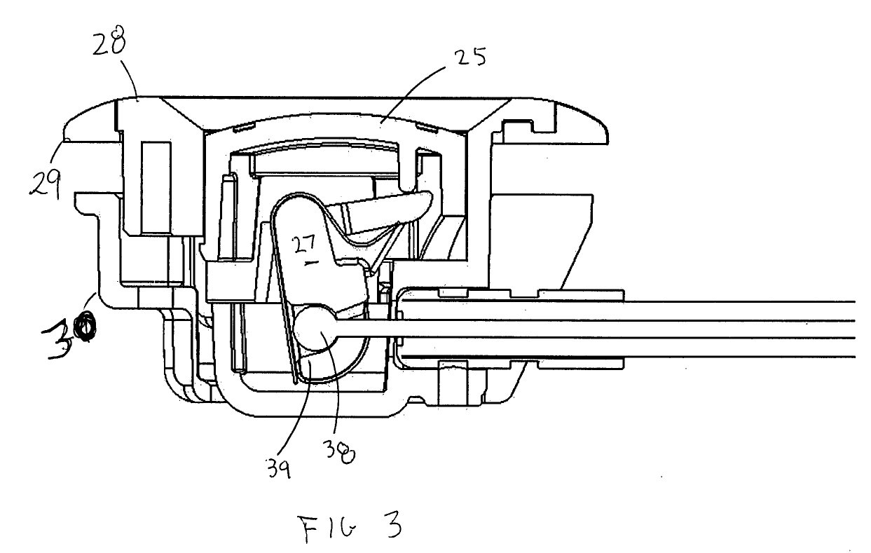

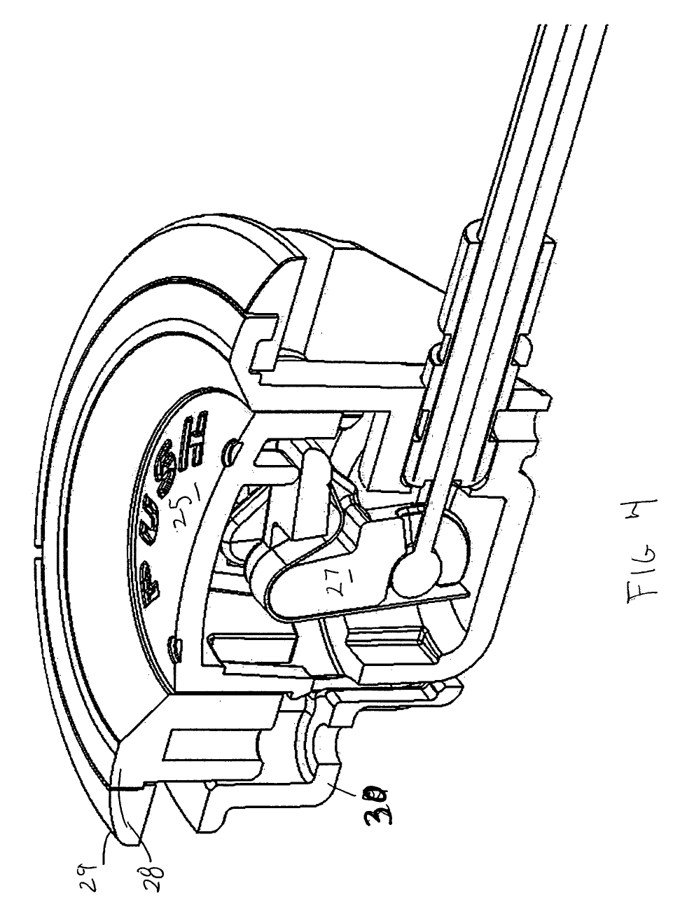

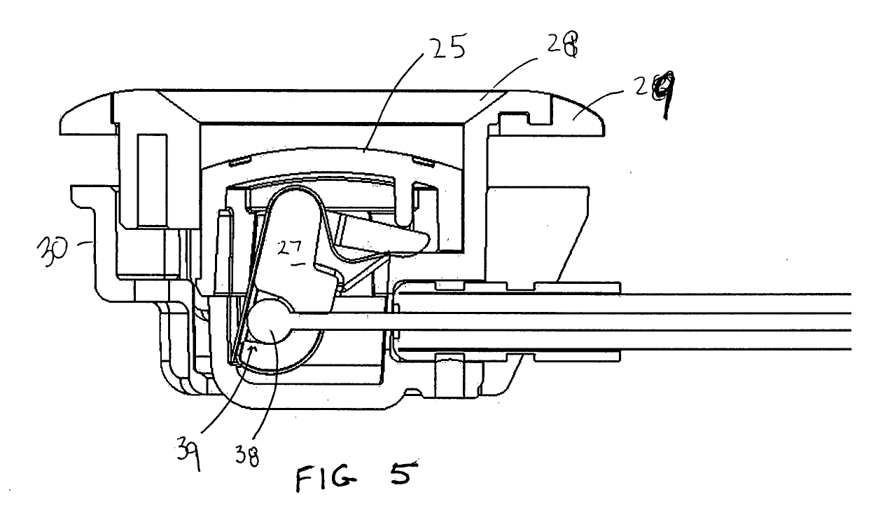

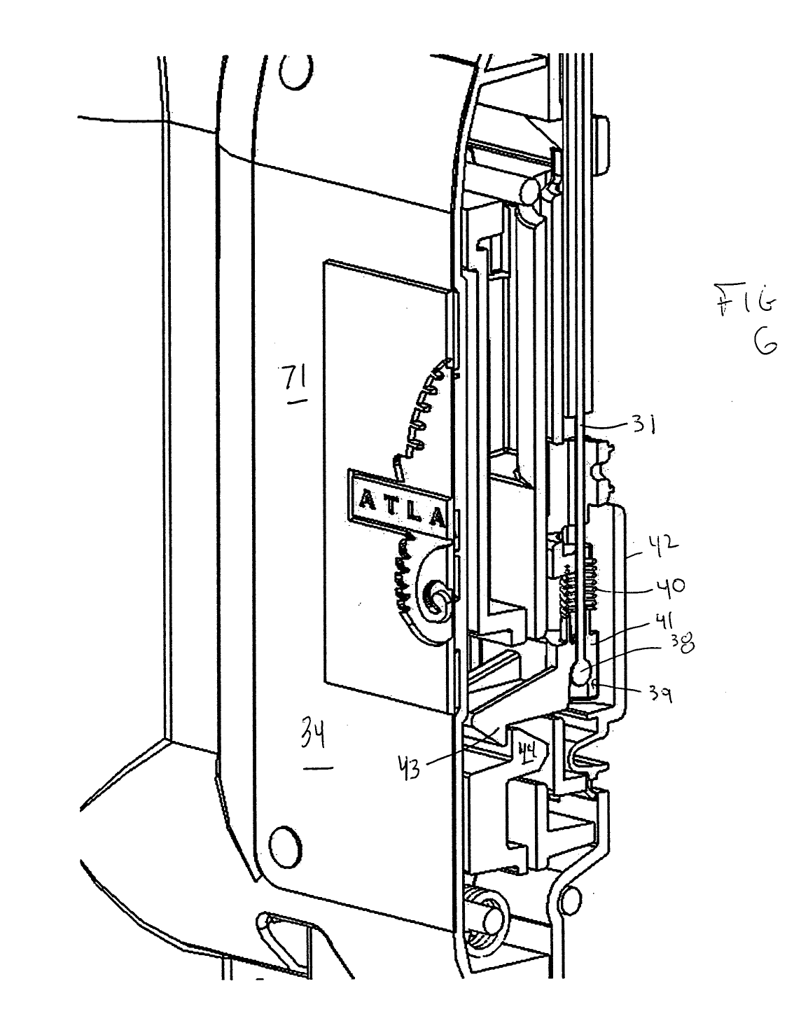

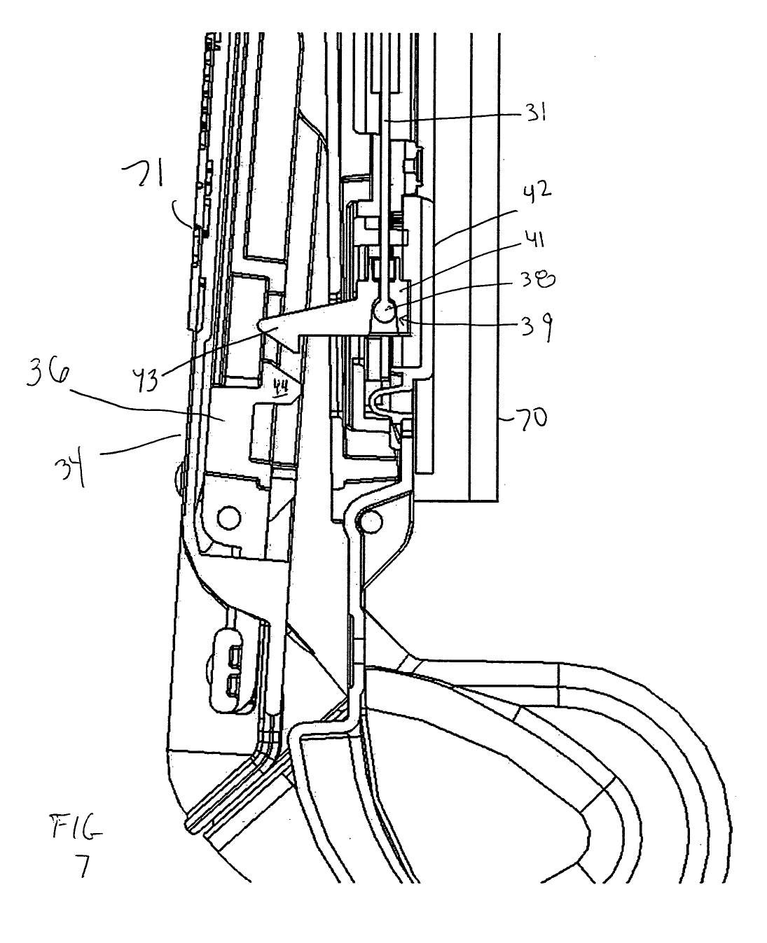

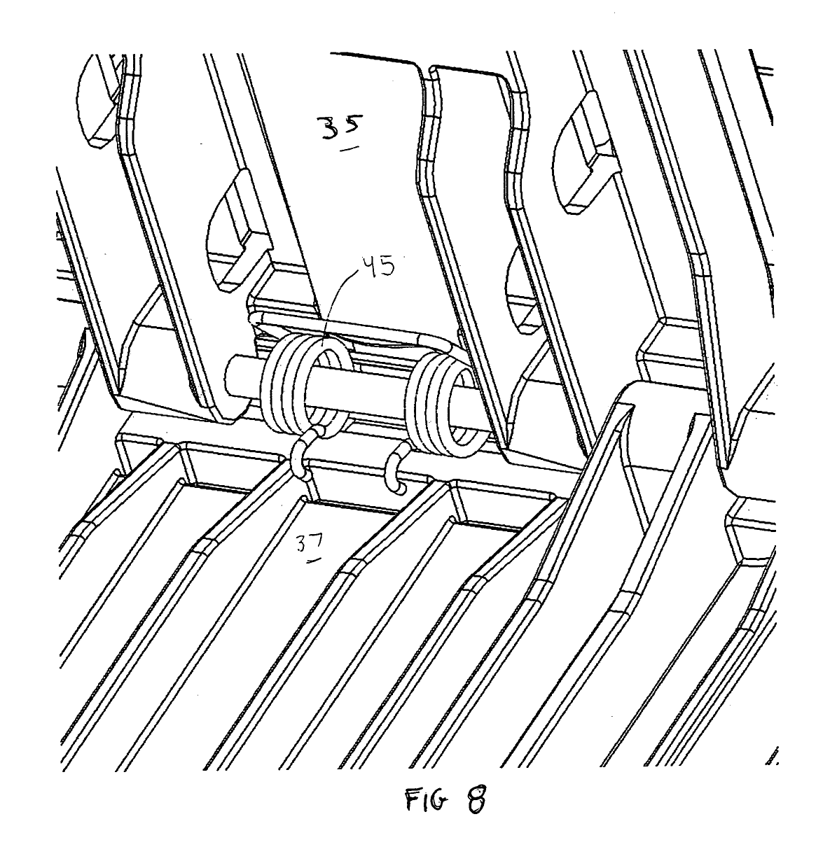

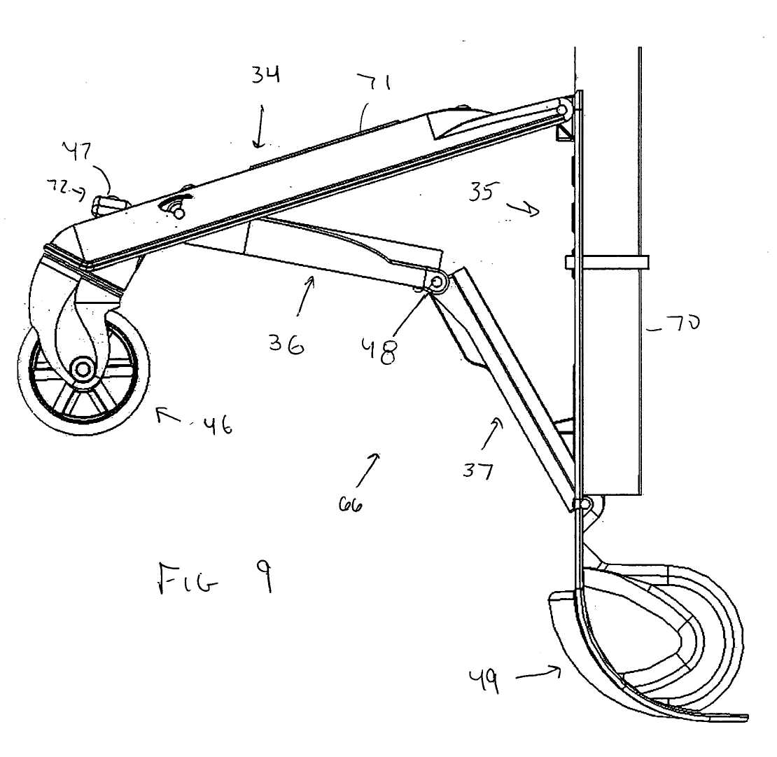

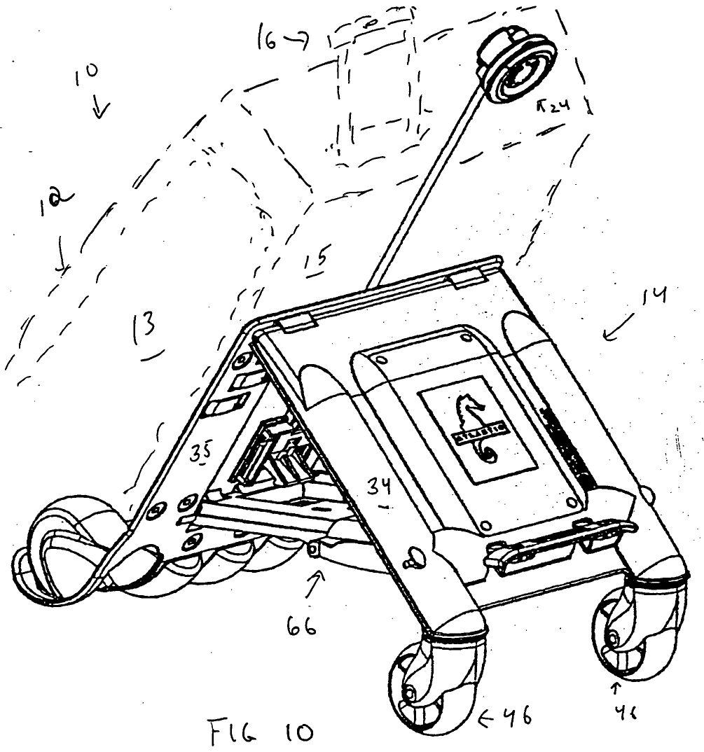

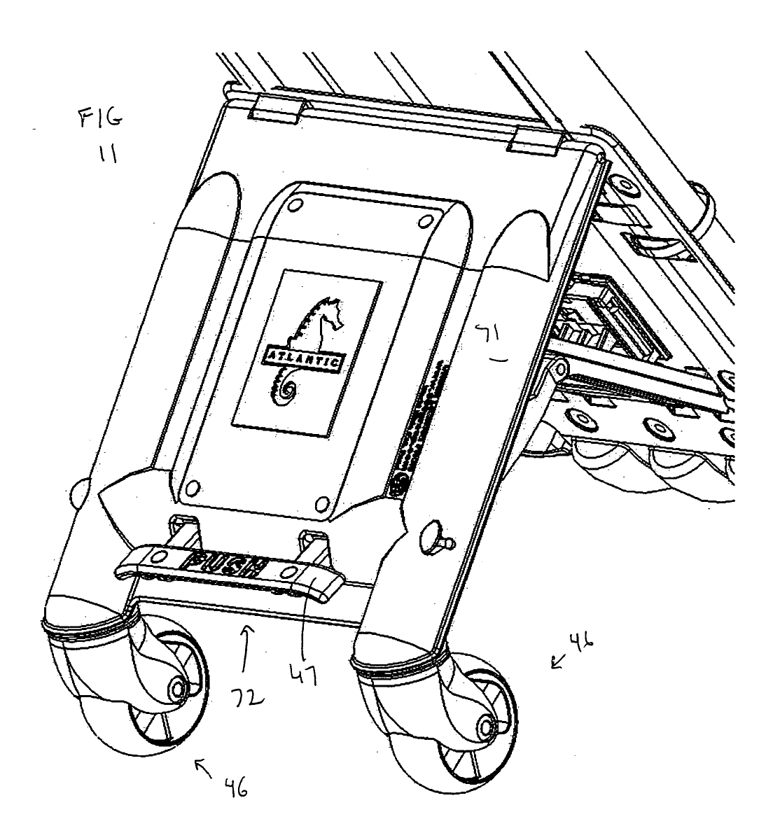

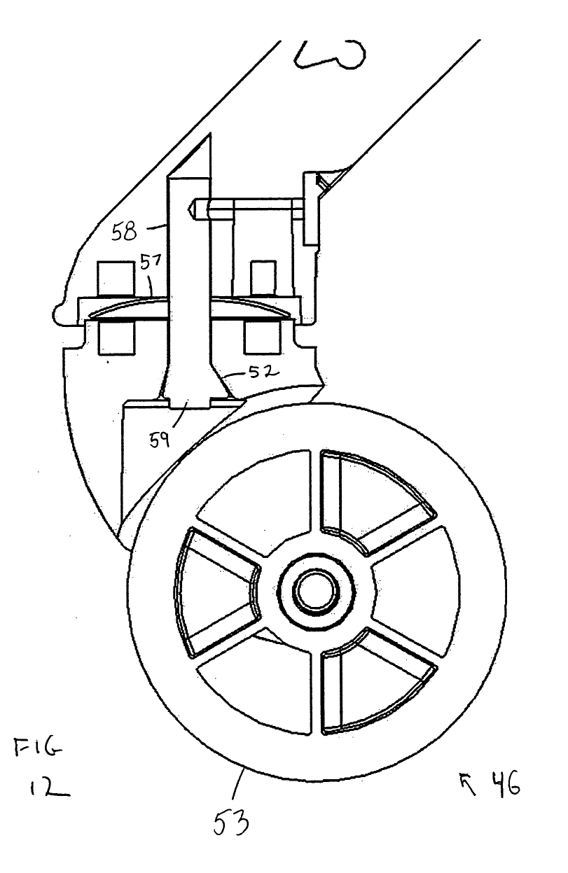

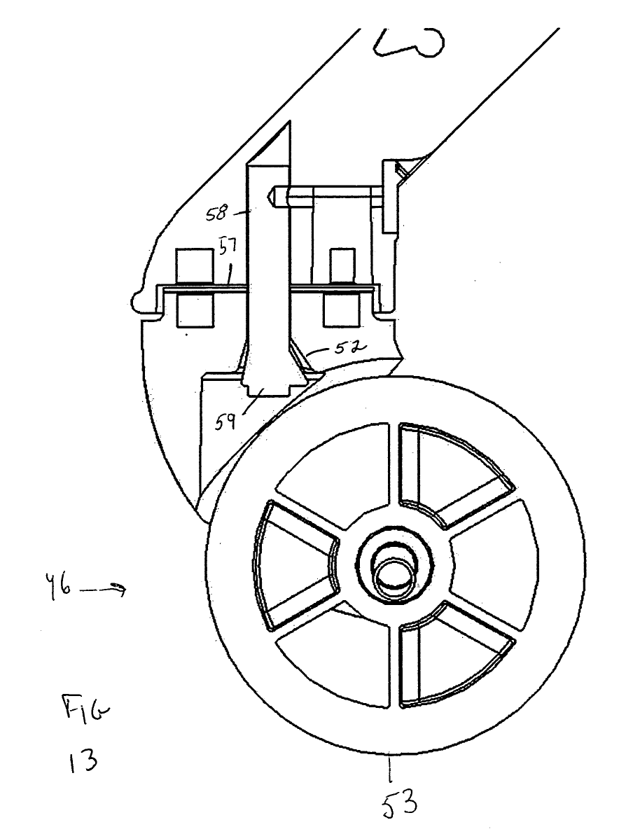

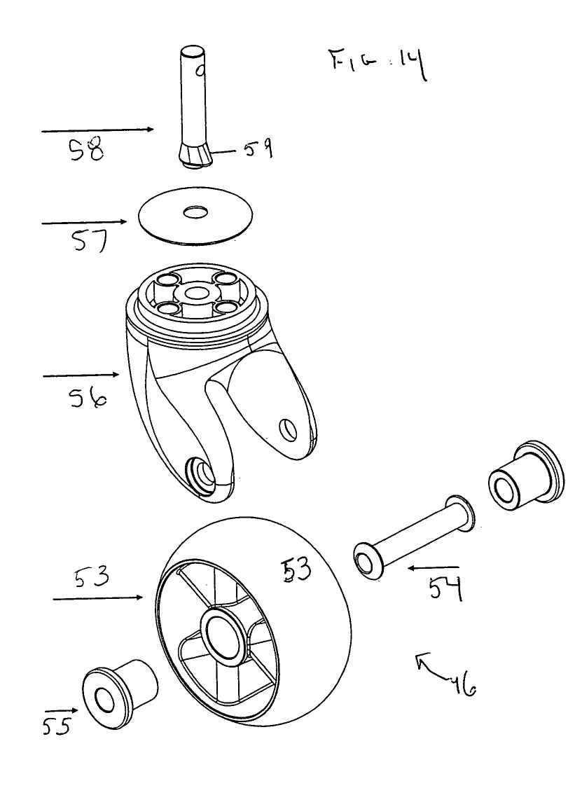

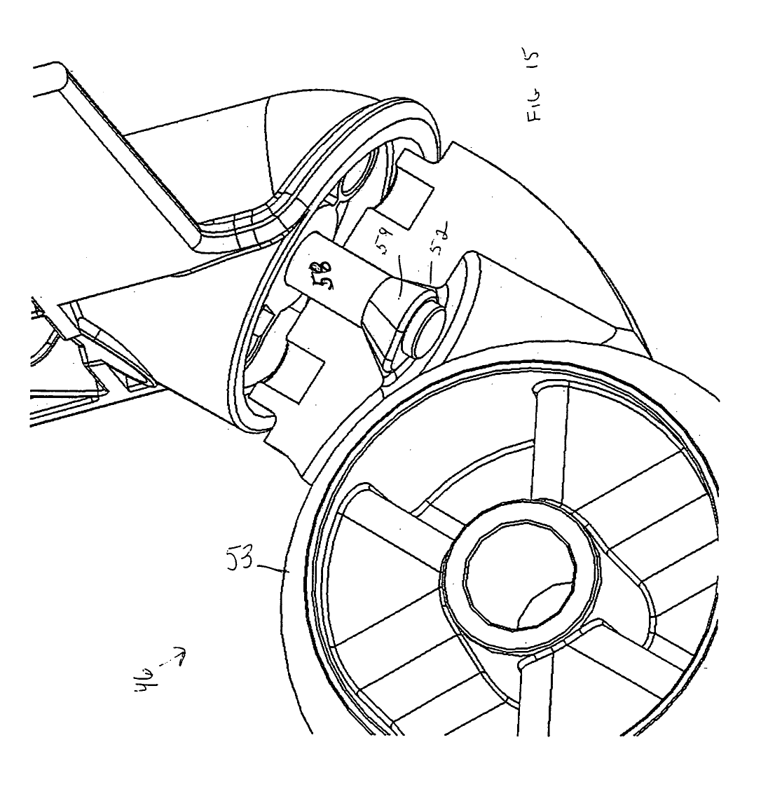

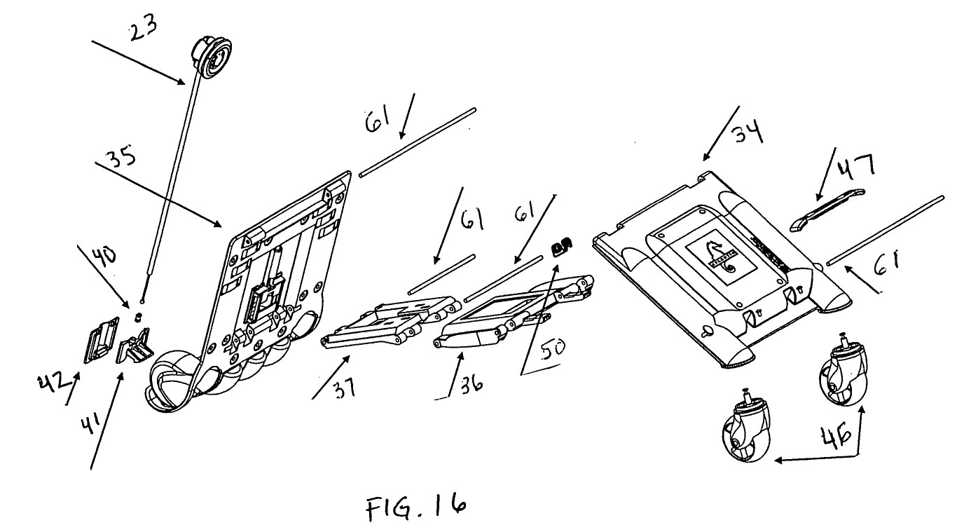

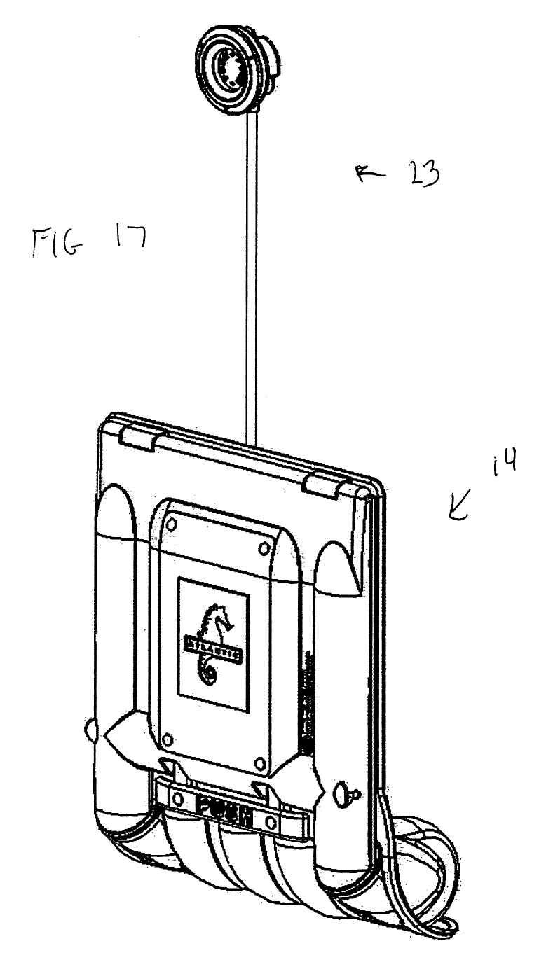

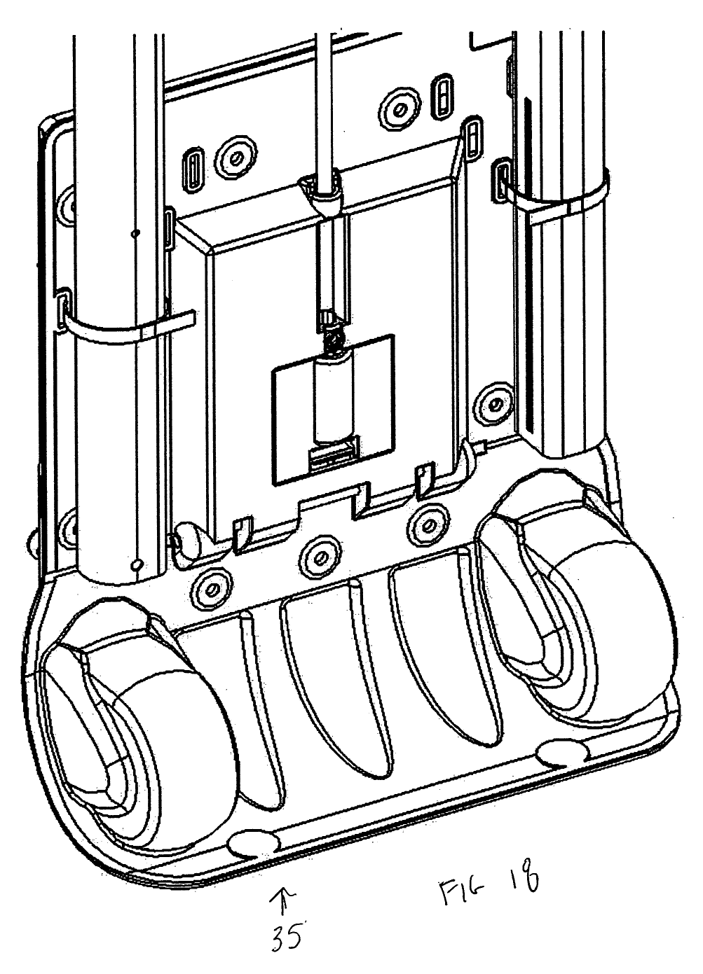

In the operation of the release mechanism 23, as shown in a preferred embodiment and FIG. 2b, there is an actuator 24 at the end of the cable that extends from the auxiliary wheel unit 14, which when activated, frees the front panel 34 of the wheel unit 14 from the back panel 35 of the wheel unit 14 which is attached to the housing 12 so the auxiliary wheel unit 14 can extend into the extended position. The actuator 24 comprises a button assembly as shown in FIG. 2a. The button assembly comprises a button 25 that is disposed over a button spring 26 which fits on a lever 27, all of which are positioned in an inner button housing 28. The inner button housing 28 fits into a trim ring 29 that in turn seats onto an outer button housing 30. There is a cable 31 whose end is fitted with a ball 38 that is positioned into the lever 27 after passing through the outer button housing 30 and inner button housing 28. The ball 38 is captured by a socket 39 of the lever 27. The cable 31 extends through a ferrule 32 and is protected by a sheath 33. FIG. 3 shows a side cross sectional view and FIG. 4 shows a prospective cross sectional view of the actuator 24 in an undepressed state. When the button 25 is depressed, it moves against the lever 27 causing the lever 27 to rotate and pull the cable 31 forward by pressing against the ball 38 at the end of the cable 31. The actuator 24 in a depressed state is shown in FIG. 5. When the button 25 is released, the button spring 26 pushes back up against the button 25 causing it to return to its undepressed position, and in turn moving the cable 31 back to its original position, as shown in FIG. 3.

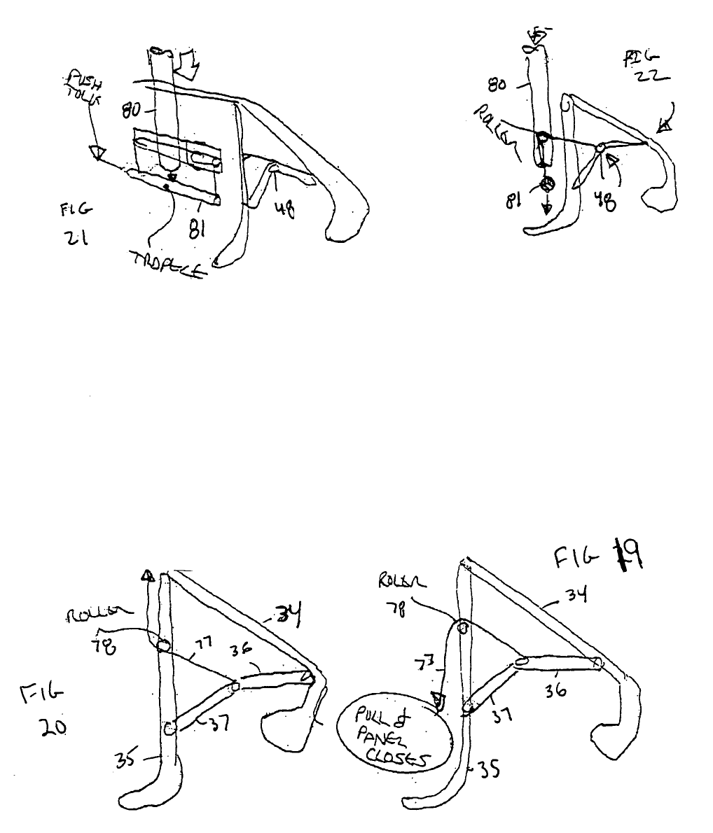

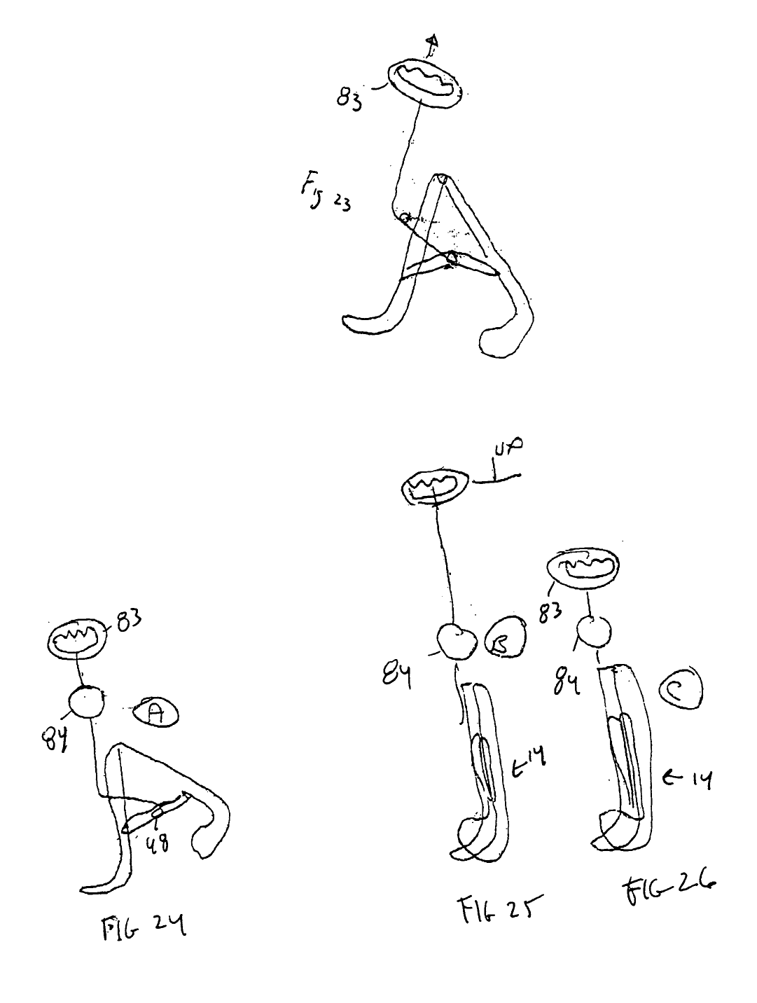

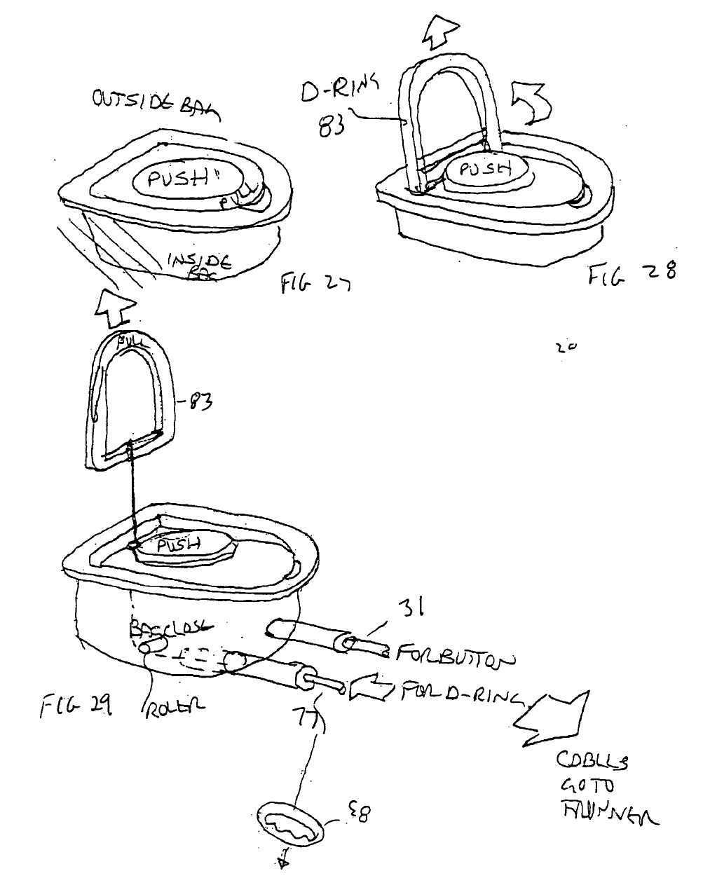

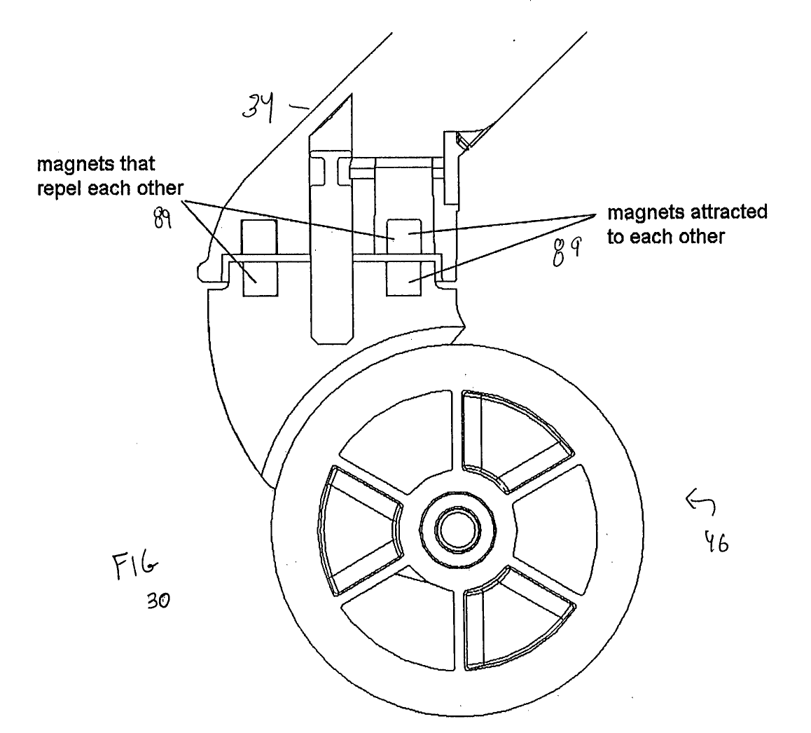

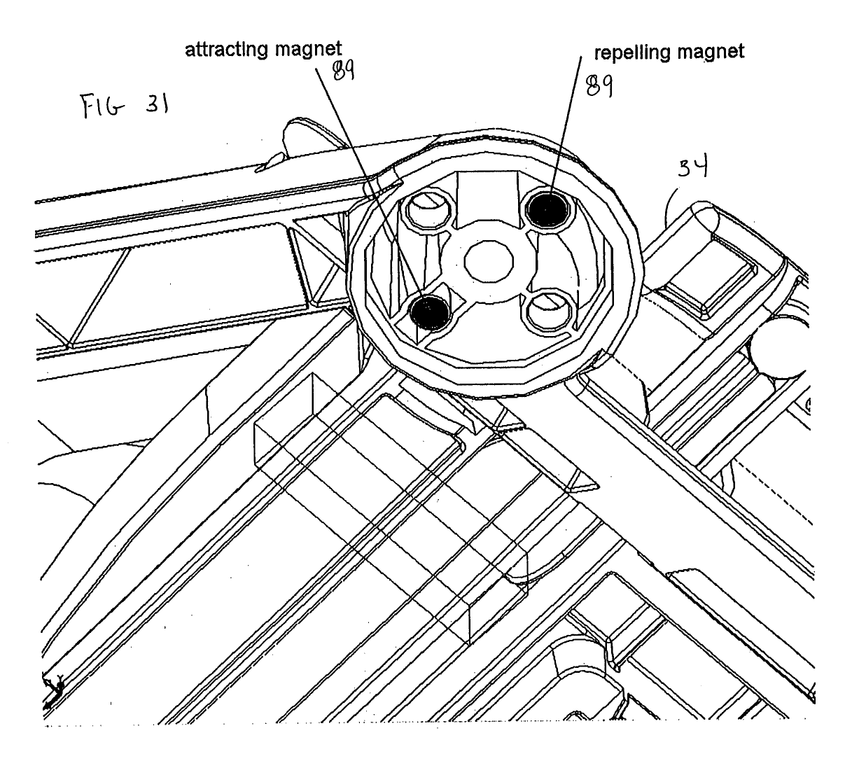

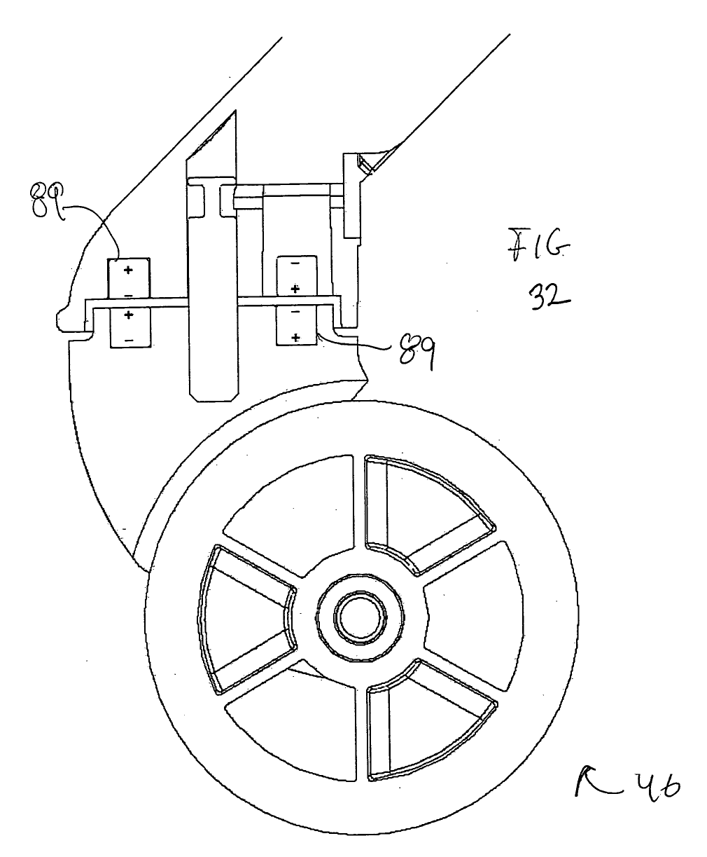

The other end of the cable 31 which is disposed in the wheel unit 14 also has a ball 38 at its end, as shown and FIGS. 6 and 7. The other end of the cable 31 extends into the back panel 35 of the wheel unit 14 through a torsion spring 40 and into a slider 41 that also has a socket 39 which captures the ball 38 of the other end of the cable 31. The torsion spring 40 and the slider 41 are enclosed by a door 42 fitted on the back panel 35. The torsion spring 40 presses down against the slider 41, keeping the latch 43 of the slider 41 down and shut against the front link 36. When the button 25 is depressed and causes the cable 31 to be pulled forward, this results in the other end of the cable 31 to pull up, with the slider 41 being pulled up by the ball 38 at the other end of the cable 31. The slider 41 is then lifted, raising the latch 43 above a catch 44 in the front link 36, allowing the front link 36 and thus the front panel 34 to become free and extend into an extended position. Rods 61 are used for rotational purposes.

When the latch 43 moves above the catch 44 in the front link 36, releasing the front link 36, a coil spring 45 attached to the back panel 35 and the back link 37 expands, automatically opening the wheel unit 14. See FIG. 8 which shows the coil spring 45 attached to the back panel 35 and the back link 37, and FIG. 9 which shows the front panel 34 in a partially extended position as the front link 36 and back link 37 move into alignment under the force of the coil spring 45. FIG. 10 shows the wheel unit 14 in the extended state. The front link 36 and the back link 37 are in linear alignment when the wheel unit 14 is in the extended state so forces can be transferred from the housing 12 to the casters 46 of the wheel unit 14 in a stable and secure manner through the front link 36 and back link 37, and the front panel 34.

When it is desired to place the wheel unit 14 back into a retracted state, an individual pushes or steps on a bar 47 extending from the front panel 34 and connected to the front link 36, as shown in FIG. 11. Referring back to FIG. 9, when the bar 47 is pushed down, it effectively lifts the front link 36, breaking the linear alignment of the front link 36 and back link 37, allowing the front link 36 and back link 37 to rotate about a common hinge 48 and close on each other as the front panel 34 is moved back in contact with the back panel 35. A hinge spring 50 is disposed in the hinge 48 to assist in the collapse of the wheel unit 14 into the retracted state. The casters 46 that extend from the front panel 34 move into their respective slots 49 where they are in a retracted position in the back panel 35. As the front panel 34 moves back in contact with the back panel 35 and into the retracted state, the latch 43 slides up as the groove 44 moves along the latch 44 until the latch 43 catches with the groove 44; and the coil spring 45 has been compressed and is armed and ready for deployment of the wheel unit 14 when the button 25 is depressed, causing the slider 41 to lift.

Each caster of the wheel unit 14 is able to move freely in its operative position and when it is weight bearing, and self aligns via means of a shoe 52 to fit into the slot 49 when the wheel unit 14 is in the retracted state. Referring to FIGS. 12, 13, 14 and 15, there is shown the caster 46 in the retracted state, and the caster 46 in the extended state and bearing weight, an exploded view of the caster 46, and a perspective view of the caster 46 engaged with the front panel 34, respectively. As shown in FIG. 14, the castor 46 comprises a wheel 53, axle 54, bushing 55 fitted to a body 56 that has a washer 57 on it through which it receives a post 58. When there is no weight on the castor 46, the washer 57 exerts a force like that from a spring and causes the base 59 of the post 58 to seat within the shoe 52, and by doing so be aligned in a desired position to fit into a slot 49. When weight is placed on the caster 46, as is the case when it is in operation and supporting the housing 12 as it is being pulled by the handle 16, the washer 57 is compressed and the base 59 of the post 58 moves out of the shoe 52 to be free to rotate as desired depending on the direction that the user pulls the housing 12.

FIG. 16 is an exploded view of the bag 10. FIG. 17 shows a wheel unit 14 and the release mechanism 23. FIG. 18 shows a back panel 35.

In regard to moving the wheel unit 14 into the retracted state, FIG. 19 and FIG. 20 show alternative embodiments where a second cable 77 extends from the linkage hinge 48 and passes under (as FIG. 20) or over (FIG. 19) a roller 78 connected to the back panel 35. When the second cable 77 is pulled, the linkage hinge 48 is pulled up, breaking the linear alignment between the front link 36 and the back link 37, allowing the front panel 34 to close upon the back panel 35.

FIGS. 21 and 22 show another embodiment where a leg 80 of the handle 16 is in alignment with a plate 81. The roller 78 is in spaced relation relative to the plate 81 and the second cable extends from the plate 81 over the roller 78 and to the linkage hinge 48. When the handle 80 moves down, it pushes down against the plate 81, causing the second cable 77 to be pulled with it, thus pulling up the linkage hinge 48.

FIG. 23 shows another embodiment similar to that shown in FIGS. 19 and 20, but there is a handle 83 connected to the second cable 77 to facilitate the pulling action on the second cable 77. FIGS. 24, 25 and 26 are further extensions of this embodiment, where there is included a starter reel 84 through which the second cable 77 is connected to the handle 83. Similar to the action of starting a lawn mower, the handle is pulled, causing the wheel unit 14 to close. The handle 83 is then released, where the starter reel 84 automatically pulls the second cable 77 back to its original position.

FIGS. 27, 28 and 29 show another embodiment where the handle 83 can be integrated into the button assembly. The handle 83 has a shape that would fit around the button 25 of the button assembly, as shown in FIG. 27. In operation, the handle 83 is pivoted upwards so that it can be gripped, and then pulled, as shown in FIG. 29. The cable 31 for the button would extend out of one port of the button assembly, while the second cable 77 extends out another port of the button assembly and be connected with the handle 83.

FIGS. 30-34 are schematic representations of the castor 46 in an embodiment where magnets 89 are used to self-align the castor 89 to be properly positioned for the retracted state. The magnets 89 are oriented so that the magnets 89 in the castor 46 will either be attracted to or be repelled by the magnets of the front panel 34. If the magnets 89 are not in alignment, the forces will repel each other, and instead the magnets that are attracted to each other will be moved to each other, thus self-aligning the castor 46 for the retracted state.

FIGS. 35-37 are schematic representations of an embodiment where a plunger 91 is used to close the wheel unit 14. FIG. 33 shows the plunger 91 which is pulled up in preparation for closing the wheel unit 14. As the plunger 91 is pulled up, it slides along a ratchet 92 that is connected to the second cable that extends to the linkage hinge 48 of the wheel unit 14. When the plunger 91 is pushed down, teeth 93 on a plunger 91 now catch on the ratchet 92, causing the ratchet to rotate and pull up the cable connector to the linkage hinge 48, pulling up and moving the wheel unit 14 into the retracted state.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A bag comprising:
a housing having a storage area and a surface;
an extendable handle connected to the housing;
an auxiliary wheel unit having at least one castor connected to the surface which in an extended state extends from the surface at an angle of at least 15 degrees to form an extended support base for the housing, and in a retracted state folds against and is essentially in parallel with the surface; and
a release mechanism having a cable which extends from the wheel unit for releasing the wheel unit from the surface to extend into the extended position.

2. A bag as described in claim 1 wherein the release mechanism includes an actuator connected with the cable and remote from the wheel unit.

3. A bag as described in claim 2 wherein the actuator includes a button assembly.

4. A bag as described in claim 3 wherein the button assembly includes a button which, when depressed into a depressed state, moves the cable which allows the wheel unit to move to the extendable position.

5. A bag as described in claim 4 wherein the wheel unit includes a front panel, a back panel connected to the surface, and a linkage that connects the front panel with the back panel.

6. A bag as described in claim 5 wherein the button assembly includes a lever that engages with the cable, and is positioned such that when the button is depressed, the lever is moved by the button and moves the cable.

7. A bag as described in claim 6 wherein the button assembly includes a button spring in operative relationship with the button such that when the button is depressed, the button spring is compressed, and when the button is released, the button spring moves the button from the depressed state back to an undepressed state.

8. A bag as described in claim 7 wherein the release mechanism includes a slider in contact with the wheel unit and the cable so when the button is depressed into the depressed states and the cable is moved, the cable moves the slider and releases the front panel from the back panel.

9. A bag as described in claim 8 wherein the slider has a latch, and the linkage has a front link and a back link, and a linkage hinge connected to the front link and the back link, the front link having a groove which engages with the latch to hold the front panel with the back panel in the retracted state.

10. A bag as described in claim 9 wherein the wheel unit includes a coil spring which, when the slider is lifted and the latch moves apart from the groove, automatically moves the wheel unit into the extended state, where the front link and back link are in linear alignment.

11. A method for moving a bag comprising the steps of:
activating a release mechanism having a cable which extends from an auxiliary wheel unit having at least one castor connected to a surface of a housing having a storage area which in an extended position extends from the surface at an angle of at least 15 degrees to form an extended support base for the housing, and in a retracted state folds against and is essentially in parallel with the surface; and
releasing the wheel unit from the surface to extend into the extended position.

12. A method as described in claim 11 wherein the activating step includes the step of activating an actuator of the release mechanism connected with the cable and remote from the wheel unit.

13. A method as described in claim 12 wherein the activating step includes the step of depressing a button of a button assembly of the actuator to place the button into a depressed state which moves the cable which allows the wheel unit to move to the extendable position.

14. A method as described in claim 13 wherein the depressing step includes the step of depressing the button to move a lever which moves the cable.

15. A method as described in claim 14 wherein the depressing step includes the step of depressing the button which compresses a button spring in operative relationship with the button, and releasing the button so the button spring moves the button from the depressed state back to an undepressed state.

16. A method as described in claim 15 wherein the depressing step includes the step of moving a slider of the release mechanism in contact with the wheel unit and the cable when the button is depressed into the depressed states and the cable is moved to release the front panel from the back panel.

17. A method as described in claim 16 wherein the moving step includes the step of lifting a latch of the slider apart from a groove of a first link of a linkage of the wheel unit, causing a coil spring attached to the back panel to automatically move the wheel unit into the extended state, where the front link and a back link of the wheel unit are in linear alignment.

18. A bag comprising:
a housing having a storage area and a surface;
an extendable handle connected to the housing; and
an auxiliary wheel unit having a back connected to the surface, a front and at least one castor which in an extended state extends from the surface at an angle of at least 15 degrees to form an extended support base for the housing, and in a retracted state folds against and is essentially in parallel with the surface, the wheel unit having a pressure mechanism extending from the front which, when depressed allows the wheel unit to move from the extended state to the retracted state.

19. A bag as described in claim 18 wherein the wheel unit includes a front panel having the front, a back panel having the back, and a linkage connected to the front panel and the back panel.

20. A bag as described in claim 19 wherein the linkage includes a front link connected to the front panel, a back link connected to the back panel and a linkage hinge connected to the front link and the back link about which the front link and the back link rotate as they move between the extended state, where the front link and the back link are in linear alignment, and the retracted state, where the front link and the back link are essentially folded together.

21. A bag as described in claim 20 wherein the pressure mechanism includes a bar disposed along the front of the front panel and connects with the front link so when the wheel unit is in the extended state and the bar is depressed, the front link is caused to be moved relative to the linkage hinge, breaking the linear alignment with the back link and allowing the front panel and the front link to be folded together with the back link and the back panel.

22. A method for moving a bag comprising:
placing an auxiliary wheel unit having a back connected to a surface of a housing having a storage area, a front and at least one castor into an extended state where the wheel unit extends from the surface at an angle of at least 15 degrees to form an extended support base for the housing;
pulling the housing by an extendable handle connected to the housing;
depressing a pressure mechanism of the wheel unit extending from the front which allows the wheel unit to move from the extended state to a retracted state where the wheel unit folds against and is essentially in parallel with the surface; and
moving the wheel unit into the retracted state.

23. A method as described in claim 22 wherein the moving step includes the step of rotating a front link connected to a front panel having the front of the wheel unit relative to a back link connected to a back panel having the back of the wheel unit about a linkage hinge connected to the front link and the back link as they move between the extended state, where the front link and the back link are in linear alignment, and the retracted state, where the front link and the back link are essentially folded together.

24. A method as described in claim 23 wherein the depressing step includes the step of depressing a bar of the pressure mechanism disposed along the front of the front panel and connected with the front link causing the front link to be moved relative to the linkage hinge, breaking the linear alignment with the back link and allowing the front panel and the front link to be folded together with the back link and the back panel.

25. A method as described in claim 24 including the steps of;
activating a release mechanism having a cable which extends from the auxiliary wheel unit; and
releasing the wheel unit from the surface to extend into the extended position.

26. A bag as described in claim 10 including a release mechanism having a cable which extends from the wheel unit for releasing the wheel unit from the surface to extend into the extended position.
